(19) United States
(12) Patent Application Publication
(10) Pub. No.: US 2015/0249340 A1
(43) Pub. Date: Sep. 3, 2015

(54) POWER RELAY STAND

(71) Applicant: Kabushiki Kaisha Toshiba, Tokyo (JP)

(72) Inventors: Seiji Hashimoto, Tokyo (JP); Hideaki Haruyama, Fujisawa Kanagawa (JP)

(21) Appl. No.: 14/623,421

(22) Filed: Feb. 16, 2015

Related U.S. Application Data
(63) Continuation of application No. PCT/JP2013/057701, filed on Mar. 18, 2013.

(51) Int. Cl. H02J 5/00; H02J 7/02

(52) U.S. Cl. CPC H02J 5/005; H02J 7/025

(57) ABSTRACT

According to one embodiment, a power relay stand which supports an electronic device includes a receiver, a transfer module and a transmitter. The receiver is provided so as to face a charging stand and receives power transmitted from the charging stand through contactless power transmission. The transfer module transfers the power received by the receiver. The transmitter is provided so as to face the electronic device and transmits the power transferred from the transfer module to the electronic device through the contactless power transmission.

### CROSS REFERENCE TO RELATED APPLICATIONS

This application is a Continuation Application of PCT Application No. PCT/JP2013/057701, filed Mar. 18, 2013, the entire contents of which are incorporated herein by reference.

### FIELD

Embodiments described herein relate generally to a technique related to contactless power transmission.

### BACKGROUND

Currently, development of a contactless power transmission technique which transmits power without bringing electrodes into contact with each other is ongoing.

In general, if a contactless power transmitter for conducting contactless power transmission is provided inside the top board of a table, and an electronic device is placed on the top board, electricity can be transferred from the contactless power transmitter to the electronic device. Some electronic devices such as tablet computers are, when placed on the top board, difficult for the user to handle.

In consideration of the above factor, a power relay stand which enables the user to easily handle an electronic device by supporting the electronic device and relays power transmitted from a contactless power transmitter to the electronic device is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of an outer appearance of an electronic device according to an embodiment.

FIG. 2 is an exemplary block diagram showing an example of a system configuration of the electronic device according to the embodiment.

FIG. 3 shows a state where the electronic device receives power through contactless power transmission.

FIG. 4 is shown for explaining contactless power transmission performed by a contactless power transmitter and a contactless power receiver.

FIG. 5 shows a state where the electronic device is supported by a power relay stand.

FIG. 6 is shown for explaining a function for relaying power by the power relay stand.

FIG. 7 is an exemplary block diagram showing a structure when the power relay stand is interposed between the contactless power transmitter and the contactless power receiver.

FIG. 8 shows an example in which an inductor L is inserted into wiring inside the power relay stand.

FIG. 9 shows a measuring system which measures susceptance.

FIG. 10 shows a desirable structure of electrodes inside the power relay stand.

FIG. 11 shows an example of a structure when contactless power transmission is performed by electromagnetic induction or magnetic resonance.

### DETAILED DESCRIPTION

Various embodiments will be described hereinafter with reference to the accompanying drawings.

In general, according to one embodiment, a power relay stand which supports an electronic device comprises a receiver, a transfer module, and a transmitter. The receiver is provided so as to face a charging stand and receives power transmitted from the charging stand through contactless power transmission. The transfer module transfers the power received by the receiver. The transmitter is provided so as to face the device and transmits the power transferred from the transfer module to the device through the contactless power transmission.

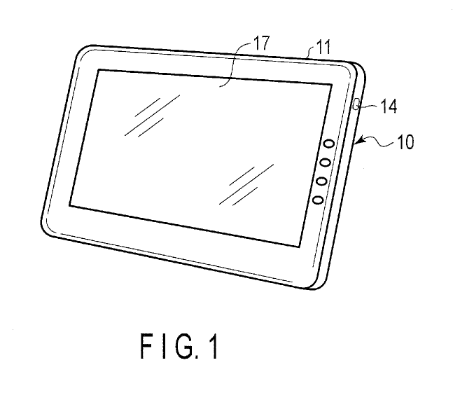

FIG. 1 is a perspective view showing an outer appearance of an electronic device according to an embodiment. The electronic device is, for example, a mobile electronic device which enables the user to conduct a pointing operation or input handwritten characters by using a stylus or a finger. The electronic device can be realized as, for example, a tablet computer, a notebook computer, a smartphone or a PDA. Hereinafter, this specification assumes that the electronic device is realized as a tablet computer 10. The tablet computer 10 is a mobile electronic device also called a tablet or a slate computer.

A computer main body 11 comprises a housing having a thin-box shape. On the superficial aspect of the computer main body 11, a power button 14 for turning the computer 10 on or off is provided. A touchscreen display 17 is provided on the superficial aspect of the computer main body 11. The touchscreen display 17 comprises a flat-panel display (for example, a liquid crystal display (LCD)) and a touchpanel. The touchpanel is provided so as to cover the screen of the LCD. The touchpanel is configured to detect the position touched by a finger of the user or a stylus on the touchscreen display 17.

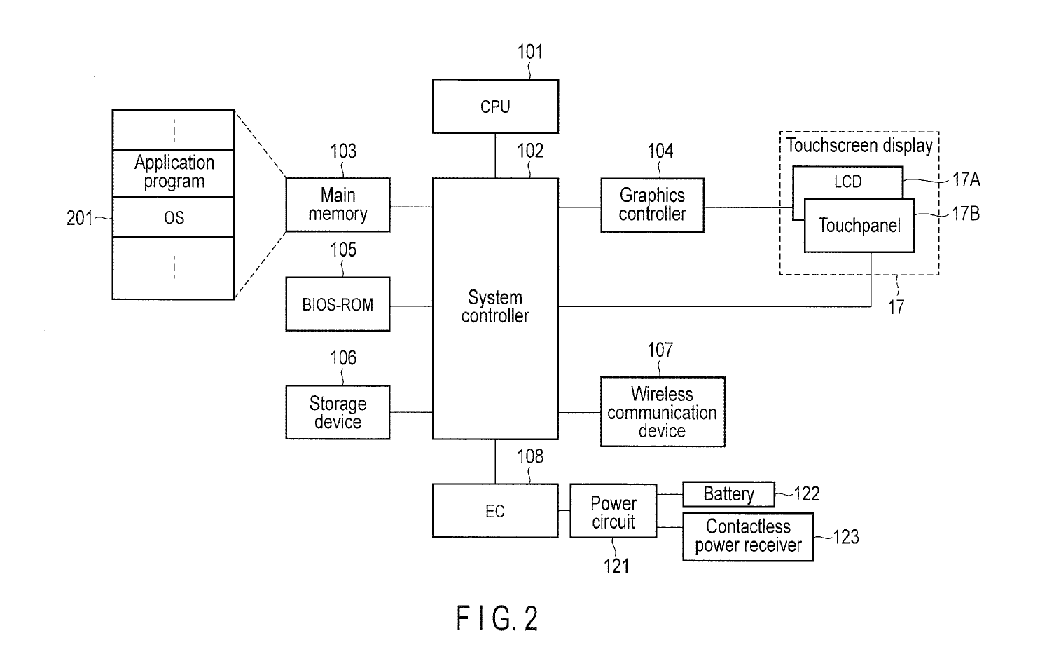

FIG. 2 shows a system configuration of the tablet computer 10 according to the embodiment.

The tablet computer 10 comprises, as shown in FIG. 2, a CPU 101, a system controller 102, a main memory 103, a graphics controller 104, a BIOS-ROM 105, a storage device 106, a wireless communication device 107, an embedded controller (EC) 108, a power circuit 121, and a contactless power receiver 123, etc.

The CPU 101 is a processor configured to control operations of various modules of the tablet computer 10. The CPU 101 executes various programs loaded from the storage device 106 into the main memory 103. The programs executed by the CPU 101 include an operating system (OS) 201 and various application programs.

The CPU 101 also executes a basic input/output system (BIOS) stored in the BIOS-ROM 105. The BIOS is a program for hardware control.

The system controller 102 is a device which connects a local bus of the CPU 101 and various components. The system controller 102 comprises a built-in memory controller which controls access to the main memory 103. The system controller 102 has a function for performing communication with the graphics controller 104 via a serial bus.

The graphic controller 104 is a display controller which controls an LCD 17A used as a display monitor of the tablet computer 10. A display signal generated by the graphics controller 104 is sent to the LCD 17A. The LCD 17A displays a screen image based on the display signal. As a position detecting device, a touchpanel 17B is provided on the LCD 17A. The touchpanel 17B is a capacitive pointing device for conducting an input operation on the screen of the LCD 17A. The contact position on the screen with a finger and the move of the contact position are detected by the touchpanel 17B.

The wireless communication device 107 is a device which performs wireless communication using a wireless LAN or 3G mobile communication, etc.

The EC 108 is a single-chip microcomputer including an embedded controller for power management. The EC 108 has a function for turning the tablet computer 10 on or off in accordance with the operation by the user relative to the power button.

The power circuit 121 generates operation power to be supplied to each component by using power supplied from a battery 122 of the computer 10 or power supplied from outside through contactless power transmission and received by the contactless power receiver 123. The power circuit 121 also charges the battery 122 by using power supplied from an external power source.

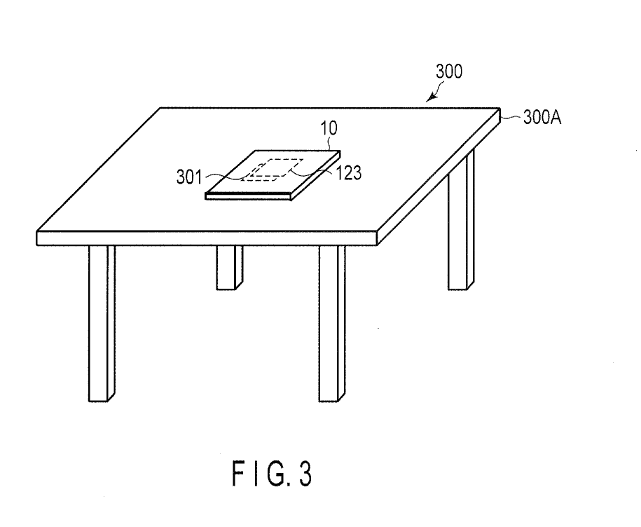

FIG. 3 shows a state in which the electronic device receives power through contactless power transmission.

As shown in FIG. 3, the computer 10 is placed on a top board 300A of a table 300 as a charging stand. Inside the top board 300A of the table 300, a contactless power transmitter 301 which transmits power through contactless power transmission is provided. The contactless power transmitter 301 is configured to move in accordance with the position of the contactless power receiver 123 of the computer 10 on the top board 300A and increase the transmission efficiency. To increase the transmission efficiency, a plurality of contactless power transmitters may be provided inside the top board 300A. The contactless power transmitters which perform contactless power transmission may switch each other in accordance with the position of the contactless power receiver 123 of the computer 10 on the top board 300A.

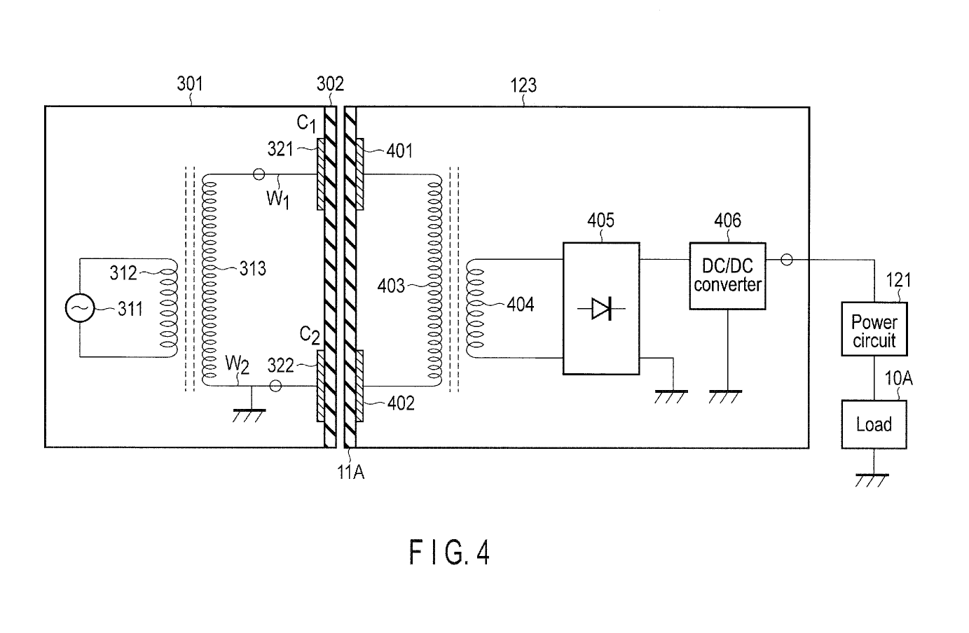

Now, this specification explains contactless power transmission performed by the contactless power transmitter 301 and the contactless power receiver 123 with reference to FIG. 4. FIG. 4 shows a structure when contactless power transmission is performed by electric field coupling.

The contactless power transmitter 301 comprises an alternating-current source 311, a primary coil 312, a secondary coil 313, electrode 321, electrode 322 and the like. One end of the secondary coil 313 is electrically connected to electrode 321 by wiring W₁. The other end of the secondary coil 313 is electrically connected to electrode 322 by wiring W₂. Wiring W₂ is connected to ground. Wiring W₂ connected to ground is preferably shorter and thicker than wiring W₁. In this manner, it is possible to suppress instability of potential of electrode 322 relative to ground of the contactless transmitter 301, reduce unnecessary radiation and stabilize the touching operation relative to the tablet computer 10.

The contactless power receiver 123 comprises electrode 401, electrode 402, a primary coil 403, a secondary coil 404, a rectification circuit 405 and a DC/DC converter 406, etc.

Capacitor C₁ comprises electrode 321 and electrode 401. Capacitor C₂ comprises electrode 322 and electrode 402.

The member denoted by reference number 302 is formed of the insulating material which forms the top board 300A. The member denoted by reference number 11A is formed of the insulating material which forms the main body 11. The member 302 and the member 11A are formed of insulating materials to prevent shock caused when a person directly contacts an electrode and prevent deterioration of electrodes 321, 322, 401 and 402.

Alternating-current power output from the alternating-current source 311 is boosted in the primary coil 312 and the secondary coil 313.

The boosted alternating-current power is transmitted from the contactless power transmitter 301 to the contactless power receiver 123 by the electric field formed between electrode 321 and electrode 401 and the electric field formed between electrode 322 and electrode 402. The alternating-current power transmitted to the contactless receiver 123 is attenuated in the primary coil 403 and the secondary coil 404.

The attenuated alternating-current power is supplied to the rectification circuit 405. The rectification circuit 405 converts the alternating-current power into direct-current power. The direct-current power is supplied to the DC/DC converter 406. The DC/DC converter 406 converts the voltage of the supplied direct-current power into a predetermined voltage. The power output from the DC/DC converter 406 is supplied to the power circuit 121. The power is supplied from the power circuit 121 to each component (load 10A) of the computer.

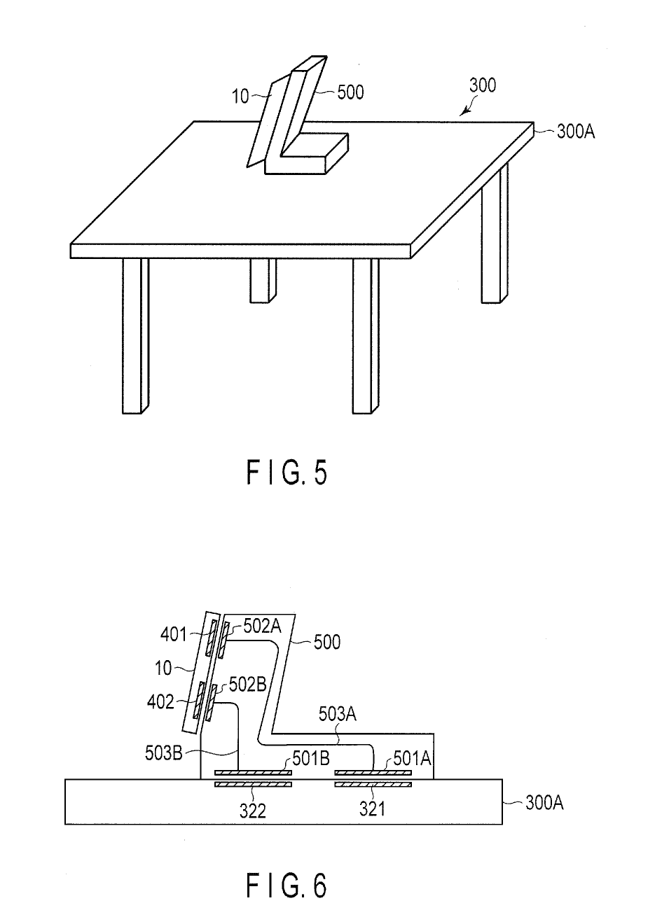

Sometimes the computer 10 is difficult to use in a state where it is placed on the top board 300A. In this case, as shown in FIG. 5, the computer 10 is supported by a stand 500 as a power relay stand. The stand 500 has a function for relaying power transmitted from the contactless power transmitter 301 to the computer 10 through contactless power transmission.

Now, this specification explains a function for relaying power by the stand 500, referring to FIG. 6.

Electrode (reception electrode) 501A and electrode (reception electrode) 501B as the receiver, electrode (transmission electrode) 502A and electrode (transmission electrode) 502B as the transmitter, and wiring 503A and wiring 503B as the relaying module are provided inside the top board 300A and the stand 500. Electrode 501A and electrode 502A are electrically connected to each other by wiring 503A. Electrode 501B and electrode 502B are electrically connected to each other by wiring 503B.

Electrode 501A and electrode 501B as the receiver are provided so as to face the top surface of the top board 300A. Electrode 501A and electrode 501B are provided so as to face a transmission position corresponding to the contactless power transmitter 301 inside the top board 300A. Electrode 502A and electrode 502B as the transmitter are provided so as to face the computer 10. Electrode 502A and electrode 502B are provided so as to face a repletion position corresponding to the contactless power receiver 123 of the computer 10.

Electrode 501A is provided so as to face electrode 321. Electrode 501B is provided so as to face electrode 322. Electrode 502A is provided so as to face electrode 401. Electrode 502B is provided so as to face electrode 402.

Power transmitted from the contactless power transmitter 301 is supplied to the contactless power receiver 123 via electrode 501A, electrode 501B, electrode 502A, electrode 502B, wiring 503A and wiring 503B inside the stand 500.

The superficial aspects of electrode 501A, electrode 501B, electrode 502A and electrode 502B may be exposed to outside. For the purpose of human-body protection, etc., insulating films may be provided on the superficial aspects of electrode 501A, electrode 501B, electrode 502A and electrode 502B.

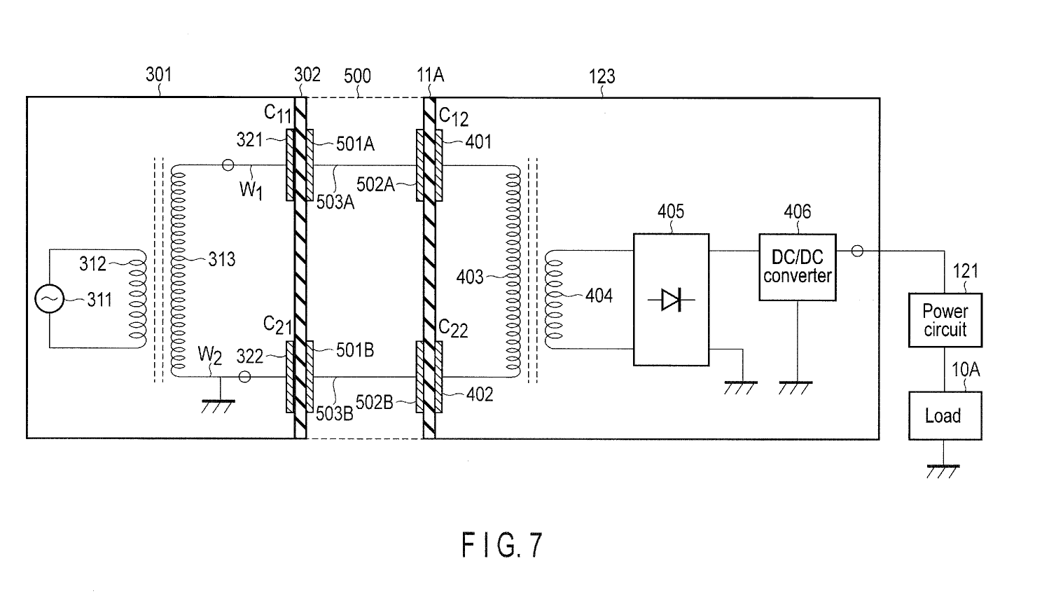

FIG. 7 is a block diagram showing a structure when the stand 500 is interposed between the contactless power transmitter 301 and the contactless power receiver 123. FIG. 7 shows a case where the superficial aspects of electrode 501A, electrode 501B, electrode 502A and electrode 502B are exposed to outside.

Capacitor C₁₁ comprises electrode 321 and electrode 501A. Capacitor C₁₂ comprises electrode 502A and electrode 401. Capacitor C₂₁ comprises electrode 322 and electrode 501B. Capacitor C₂₂ comprises electrode 502B and electrode 402.

When the superficial aspects of electrode 501A, electrode 501B, electrode 502A and electrode 502B are exposed to outside, and electrode 501A and electrode 501B adhere tightly to the member 302, and electrode 502A and electrode 502B adhere tightly to the member 11A, the synthetic capacitance of capacitor C₁₁ and capacitor C₁₂ is equal to the capacitance of capacitor C₁, and the synthetic capacitance of capacitor C₂₁ and capacitor C₂₂ is equal to the capacitance of capacitor C₂. Therefore, the insertion of the stand 500 does not cause transmission loss.

However, in practice, the electrodes do not adhere tightly to the members. Thus, the capacitance changes. To compensate for the increase in the capacitive reactance of the power transmission system by the insertion of the stand 500, an inductor may be inserted into one of wiring 503A and wiring 503B in series.

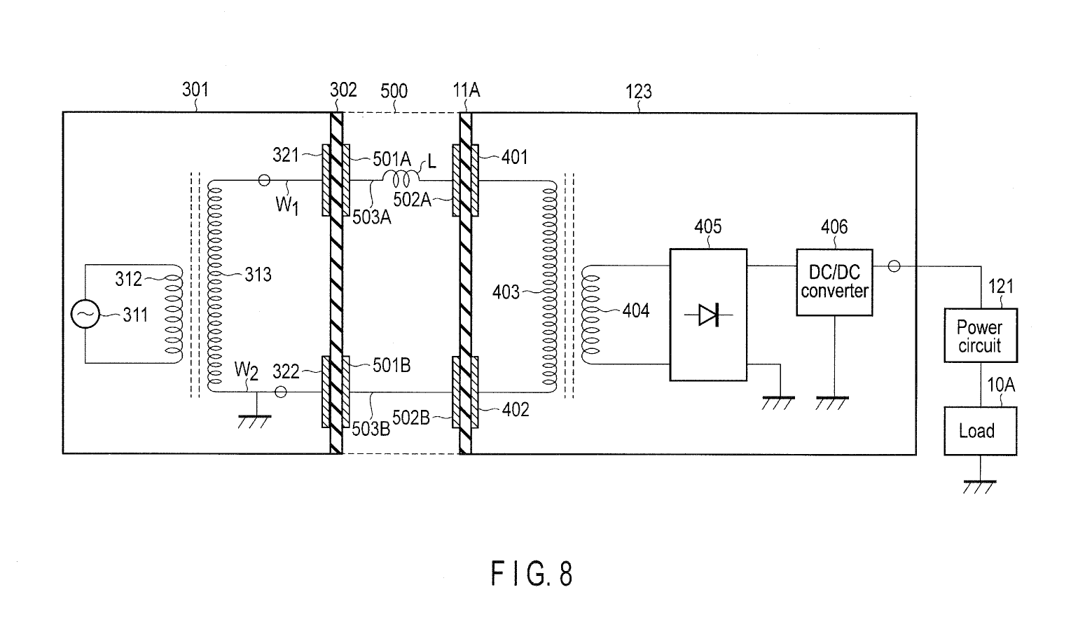

FIG. 8 shows an example in which an inductor L is inserted into wiring 503B. The inductor L is preferably inserted into wiring 503A connected to electrode 501A facing electrode 321 connected to wiring W₁ which is not connected to ground. If the inductor L is inserted into wiring 503B connected to electrode 501B facing electrode 322 connected to wiring W₂ connected to ground, electromagnetic radiation is easily caused.

The inductance of the inductor L is set so that 2πfL=Xc in order to satisfy the resonant condition in the used frequency f (Hz) when the increase in capacitive reactance is Xc.

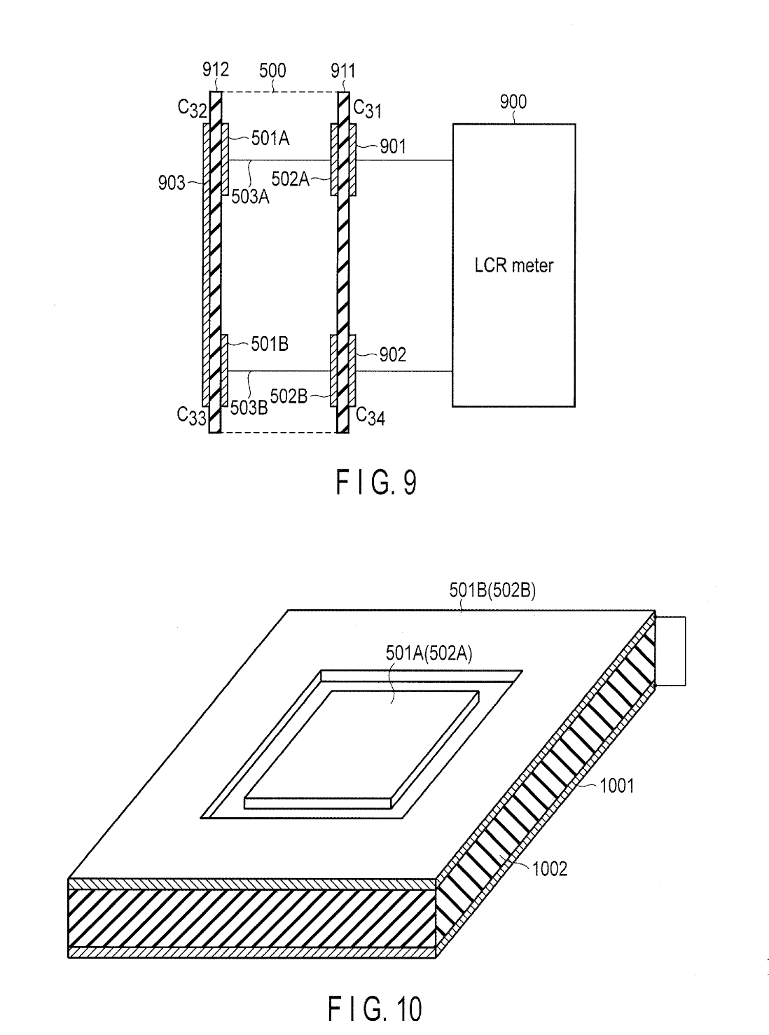

The susceptance increased by the interposition of the stand 500 can be measured by the measuring system shown in FIG. 9. As shown in FIG. 9, measuring electrode 901 and measuing electrode 902 are connected to an LCR meter 900. Electrode 901 is provided so as to face electrode 502A via insulating material 911. Electrode 902 is provided so as to face electrode 502B via insulating material 911. Electrode 903 for short-circuiting is provided so as to face electrode 501A and electrode 501B via insulating material 912.

Capacitor C₃₁ comprises measuring electrode 901 and electrode 502A. Capacitor C₃₂ comprises electrode 501A and electrode 903 for short-circuiting. Capacitor C₃₃ comprises electrode 903 for short-circuiting and electrode 501B. Capacitor C₃₄ comprises electrode 502B and measuring electrode 902.

At the time of measurement, the inductance is zero; that is, short-circuiting. The capacitive reactance Xc is (1/C₃₁ω+1/C₃₂ω+1/C₃₃ω+1/C₃₄ω), where ω is angular frequency, and ω=2πf.

The inductance L which is ultimately optimal is equal to the value calculated by dividing the sum of reactance components of the formed capacitors C₃₁ to C₃₄ by the angular frequency ω of the signal used for power transmission.

L=(1/C₃₁ω+1/C₃₂ω+1/C₃₃ω+1/C₃₄ω)/ω

In a similar manner, in the contactless power transmitter 301 as a feeding device and the contactless power receiver as a receiving device, insertion of an inductor formed in its own insulated electrode in series is effective, or insertion of an inductor in series is effective to compensate for the capacitive reactance. At this time, the inductor can be inserted to any position in theory. However, in consideration of safety and stability in operation, the inductor is preferably inserted into wiring W₁ which is not connected to ground. In the actual stand 500, change in the frequency of power is also effective to compensate for the incompleteness of inductance or the change in the capacitive reactance by the position of the computer 10.

FIG. 10 shows a desirable structure of electrodes 501A, 501B, 502A and 502B.

As shown in FIG. 10, electrode 501B (502B) corresponding to electrode 322 connected to wiring W₂ connected to ground has a flat-plate shape. An empty space having a rectangular shape is provided substantially in the central portion of electrode 501B (502B). In the space, electrode 501A (502A) corresponding to electrode 321 connected to wiring W₁ which is not connected to ground is provided. Under electrodes 501A (502A) and 501B (502B), electrode 1001 is provided. Electrode 501B (502B) and electrode 1001 are electrically connected to each other. Insulating material 1002 is provided between electrode 501A (502A) or electrode 501B (502B) and electrode 1001. As the electrodes are provided in this manner, it is possible to prevent the generation of noise.

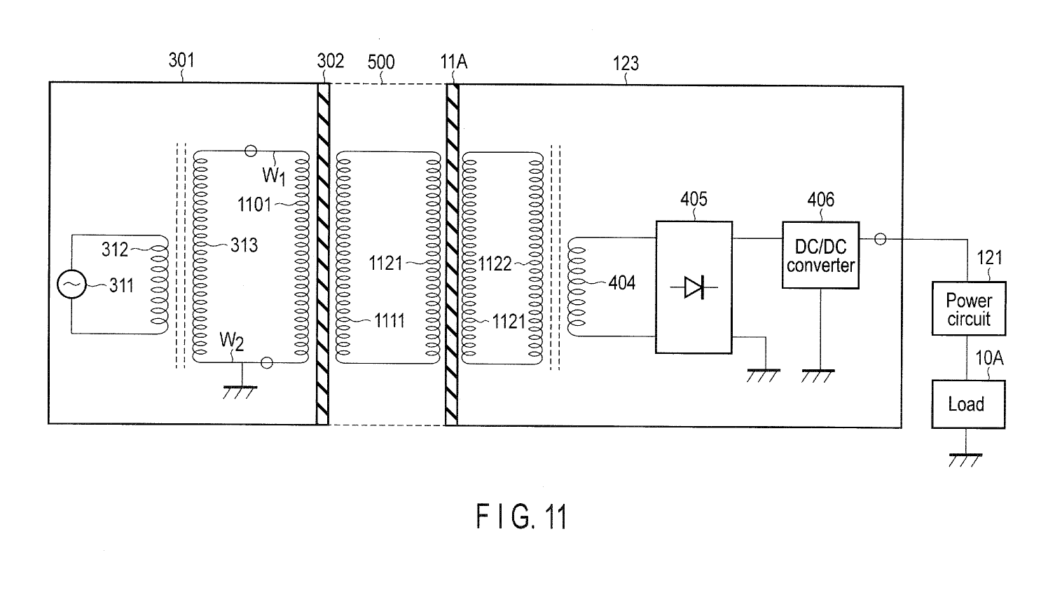

Contactless power transmission may be performed by electromagnetic induction or magnetic resonance. FIG. 11 shows a system structure when contactless power transmission is performed by electromagnetic induction or magnetic resonance.

As shown in FIG. 11, the contactless power transmitter 301 comprises transmission coil 1101 connected to the secondary coil 313. The stand 500 comprises reception coil 1111 provided so as to face transmission coil 1101. Reception coil 1111 is connected to transmission coil 1121. The contactless power receiver 123 comprises reception coil 1121. Reception coil 1121 is provided so as to face the transmission coil.

In the present embodiment, the stand 500 enables the user to easily handle the computer 10 by supporting the computer 10 and is able to relay power by using electrodes 501A and 501B provided inside the stand 500 as the receiver, wiring 503A and 503B provided inside the stand 500 as the transfer module which transfers power, and transmitters 502B and 502B which are provided inside the stand 500 and transmit the power transferred from the transfer module to the computer 10 through contactless power transmission.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power relay stand which supports an electronic device, the stand comprising:
a receiver which is provided so as to face a charging stand and receives power transmitted from the charging stand through contactless power transmission;
a transfer module which transfers the power received by the receiver; and
a transmitter which is provided so as to face the device and transmits the power transferred from the transfer module to the device through the contactless power transmission.

2. The power relay stand of claim 1, wherein
the contactless power transmission is performed by electric field coupling,
the receiver comprises a first reception electrode and a second reception electrode which are provided so as to face a first transmission position of the charging stand,
the transmitter comprises a first transmission electrode and a second transmission electrode which are provided so as to face a reception position of the device, and
the transfer module comprises a first relay line electrically connecting the first reception electrode and the first transmission electrode, and a second relay line electrically connecting the second reception electrode and the second transmission electrode.

3. The power relay stand of claim 2, further comprising a first inductor inserted into the first relay line.

4. The power relay stand of claim 3, further comprising a second inductor inserted into the second relay line.

5. The power relay stand of claim 1, wherein the contactless power transmission is performed by electromagnetic induction or magnetic resonance,
the receiver comprises a reception coil provided so as to face a first transmission position of the charging stand, and
the transmitter comprises a transmission coil provided so as to face a reception position of the electronic device.

6. A system comprising an electronic device and a power relay stand supporting the electronic device, wherein
the power relay stand comprises:
a receiver which is provided so as to face a charging stand and receives power transmitted from the charging stand through contactless power transmission;
a transfer module which transfers the power received by the receiver; and
a transmitter which is provided so as to face the electronic device and transmits the power transferred from the transfer module to the electronic device through the contactless power transmission.

7. An electronic device allowed to be supported by a power relay stand, wherein
the power relay stand comprises:
a first receiver which is provided so as to face a charging stand and receives power transmitted from the charging stand through contactless power transmission;
a transfer module which transfers the power received by the receiver; and
a transmitter which is provided so as to face the electronic device and transmits the power transferred from the transfer module to the electronic device through the contactless power transmission, and
the electronic device comprises a second receiver which is provided so as to face the transmitter and which receives the power transmitted through the contactless power transmission.
